(19) United States
(12) Patent Application Publication
(10) Pub. No.: US 2006/0274465 A1
(43) Pub. Date: Dec. 7, 2006

(54) Electrostatic discharge (ESD) protection circuits using metal-insulator-metal (MIM) capacitors

(75) Inventors: Chau-Neng Wu, Hsin-Chu (TW); Jian-Hsing Lee, Hsin-Chu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Taiwan Semiconductor Manufacturing Company, Ltd.

(21) Appl. No.: 11/140,991

(22) Filed: Jun. 1, 2005

(51) Int. Cl. H02H 9/00

(52) U.S. Cl. 361/56

(57) ABSTRACT

An electrostatic discharge (ESD) protection circuit is provided for use in an integrated circuit (IC) to provide protection against an ESD on a contact pad of the IC. The IC includes a driver circuit. The ESD protection circuit is connectable to a first power supply voltage and includes an ESD protection device connectable between the contact pad and the first power supply voltage and a capacitor connectable between the contact pad and the driver circuit.

### FIELD OF THE INVENTION

This invention relates in general to electrostatic discharge (ESD) protection circuits and, more particularly, to ESD protection circuits using metal-insulator-metal (MIM) capacitors.

### BACKGROUND OF THE INVENTION

Semiconductor integrated circuits (ICs) are susceptible to electrostatic discharge (ESD) events, during which a large amount of electrical charge, often characterized by an ESD voltage, is discharged through the IC in a very short period of time and in the form of a discharging current, which may damage or destroy the IC. Depending on the sources of the charge, an ESD event falls into one of several categories including, for example, a human-body model (HBM) ESD, a machine model (MM) ESD, etc. An HBM ESD event refers to the phenomenon that charge accumulated on a human body is discharged when the person touches a connector or an input/output (I/O) pin of the IC. An HBM ESD voltage is generally in the range of several kilovolts (KV). In an MM ESD event, charge is accumulated on a machine made of, for example, a metal plate, and is discharged when the pins of the IC come into contact-with the metal plate. An MM ESD voltage is generally in the range of several hundred volts.

FIG. 1 shows an IC 10 that includes a conventional ESD protection circuit 12. IC 10 includes a contact pad 14 coupled to an internal circuit 16 through a driver circuit 18. Driver circuit 18 comprises a PMOS transistor 20 and an NMOS transistor 22. Each of PMOS transistor 20 and NMOS transistor 22 includes a source, a drain, and a gate. The source of PMOS transistor 20 is coupled to a positive power supply V_{DD}. The source of NMOS transistor 22 is coupled to ground or a negative power supply V_{SS}. Both the gates of PMOS transistor 20 and NMOS transistor 22 are coupled to contact pad 14. Both the drains of PMOS transistor 20 and NMOS transistor 22 are coupled to internal circuit 16.

ESD protection circuit 12 is coupled between contact pad 14 and driver circuit 18 to protect driver circuit 18 and internal circuit 16 against an ESD on contact pad 14. ESD protection circuit 12 may comprise a conventional ESD protection device 24, such as a silicon-controlled rectifier (SCR) or a grounded-gate MOS transistor, which is turned on to discharge the ESD when a voltage across ESD protection device 24 exceeds a triggering voltage.

Two competing factors are typically considered when designing ESD protection device 24. First, the triggering voltage should be low enough to guarantee that ESD protection device 24 is turned on when an ESD occurs on contact pad 14. Second, ESD protection device 24 itself must be able to sustain the ESD on contact pad 14. Often times when the second condition is satisfied, the triggering voltage is so high that an ESD voltage on contact pad 14, although high enough to damage driver circuit 18, is still lower than the triggering voltage of ESD protection device 24 and therefore cannot turn on ESD protection device 24. For example, while ESD protection device 24 itself may be able sustain an HBM ESD voltage between +5.0 KV and −6.5 KV, or an MM ESD voltage between ±350 V, ESD protection circuit 12 in FIG. 1 can only protect driver circuit 18 against an HBM ESD voltage between ±1.5 KV and −6.0 KV, or an MM ESD voltage between +50 V and −400 V.

It is therefore common to use a multi-stage ESD protection circuit to provide a low triggering voltage. For example, in FIG. 2, IC 10 is modified to include a multi-stage ESD protection circuit 12A by adding an ESD protection device 26 as a secondary ESD protection element between contact pad 14 and V_{SS} and in parallel with ESD protection device 24. ESD protection device 26 is designed to have a lower triggering voltage than ESD protection device 24, such that an ESD voltage capable of damaging driver circuit 18 but incapable of turning on ESD protection device 24 may be discharged through ESD protection circuit 26.

However, ESD protection device 26 generally cannot sustain an ESD voltage as high as that sustainable by ESD protection device 24. Thus, when an ESD voltage beyond the capability of ESD protection device 26 appears on contact pad 14, ESD protection device 26 may be damaged before ESD protection device 24 is turned on to discharge the ESD voltage. As a result, ESD protection circuit 12A fails. For example, ESD protection circuit 12A may only be able to protect against an HBM ESD voltage between +0.25 KV and −6.5 KV, or an MM ESD voltage between less than +25 V and −425 V.

FIG. 3 shows IC 10 further modified in a manner intended to overcome this deficiency associated with ESD protection circuit 12A of FIG. 2. As shown in FIG. 3, IC 10 has been modified to insert a resistor 28 between ESD protection device 24 and ESD protection device 26 to lower the highest possible voltage across ESD protection circuit 26, thus forming a π-network ESD protection circuit 12B. Because of the existence of resistor 28, an ESD voltage higher than the triggering voltage of ESD protection device 24 may appear on contact pad 14 and turn on ESD protection device 24, without damaging ESD protection device 26. At the same time, resistor 28 limits a discharging current therethrough, and lowers an ESD voltage on ESD protection device 26, thereby protecting driver circuit 18. For example, ESD protection circuit 1 2B may provide protection against an HBM ESD voltage between +5.5 KV and −6.0 KV, or an MM ESD voltage between ±400 V.

A problem associated with ESD protection circuit 1 2B is that the insertion of resistor 28 between ESD protection devices 24 and 26 may result in increased circuit noise and decreased power gain.

### SUMMARY OF THE INVENTION

Consistent with embodiments of the present invention, an ESD protection circuit is provided for use in an IC to provide protection against an ESD on a contact pad of the IC. The IC includes a driver circuit. The ESD protection circuit is connectable to a first power supply voltage and includes an ESD protection device connectable between the contact pad and the first power supply voltage and a capacitor connectable between the contact pad and the driver circuit.

Consistent with embodiments of the present invention, there is also provided an ESD protection circuit for use in a high-frequency IC to provide protection against an ESD on a bonding pad of the IC, wherein the IC includes a driver circuit. The ESD protection circuit is connectable to a first power supply voltage and includes a primary ESD protection device connectable between the bonding pad and the first power supply voltage for providing a primary ESD protection, a secondary ESD protection device connectable to the first power supply voltage and the driver circuit for providing a secondary ESD protection, and a capacitor connectable between the bonding pad and the driver circuit and also coupled between the primary ESD protection device and the secondary ESD protection device.

Consistent with embodiments of the present invention, there is further provided a high-frequency IC that includes a bonding pad, a driver circuit, and an ESD protection circuit to protect the IC against an ESD on the bonding pad. The ESD protection circuit includes a primary ESD protection device coupled to the bonding pad and connectable to a first power supply voltage for providing a primary ESD protection, and a capacitor coupled between the bonding pad and the driver circuit.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention.

In the drawings,

FIG. 1 shows an integrated circuit including a conventional ESD protection circuit;

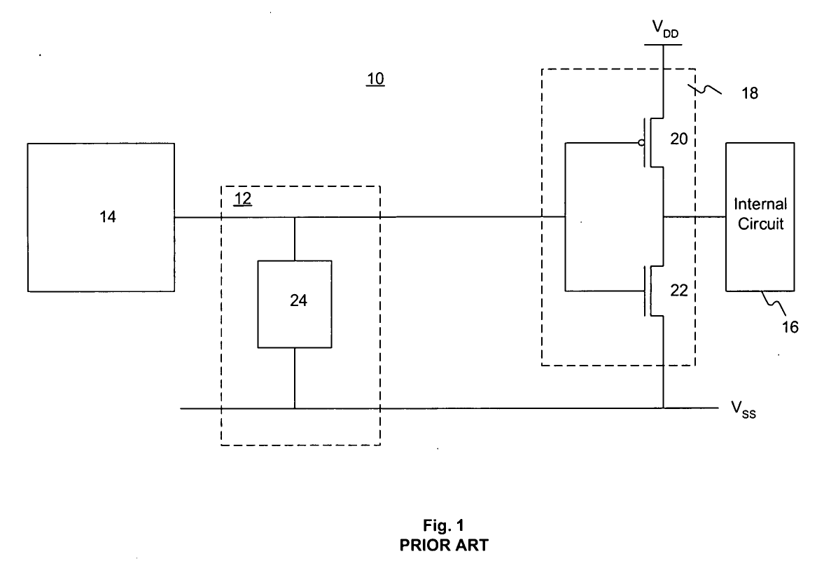

FIG. 2 shows an integrated circuit including another conventional ESD protection circuit;

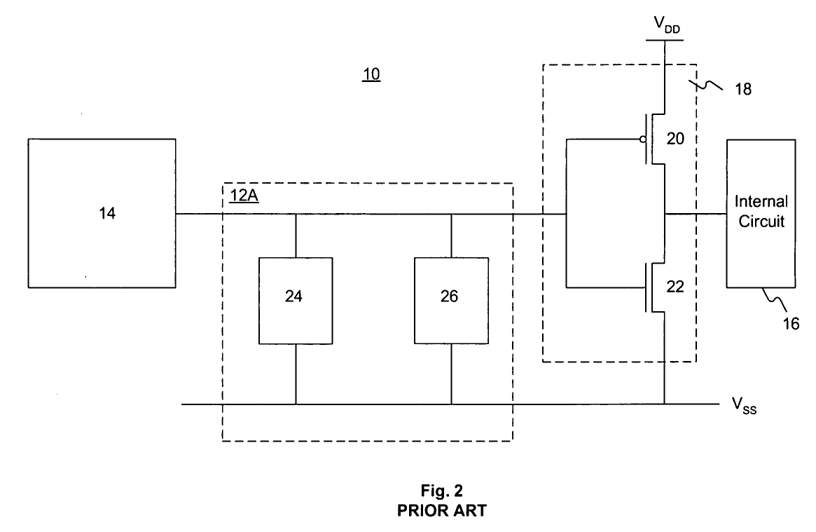

FIG. 3 shows an integrated circuit including still another conventional ESD protection circuit;

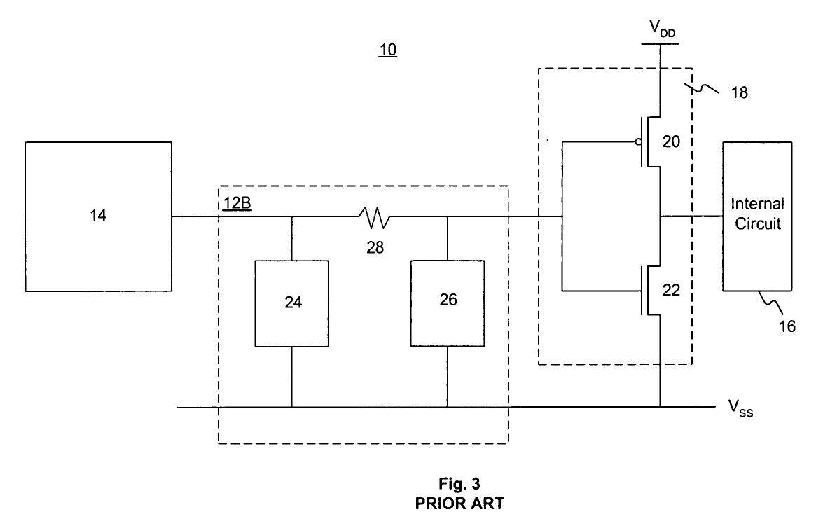

FIG. 4 shows an integrated circuit including an ESD protection circuit consistent with a first embodiment of the present invention;

FIG. 5 shows an integrated circuit including an ESD protection circuit consistent with a second embodiment of the present invention;

FIG. 6 shows the ESD protection circuit consistent with the first embodiment of the present invention being used in an integrated circuit using a bipolar junction transistor as a driver; and

FIG. 7 shows the ESD protection circuit consistent with the second embodiment of the present invention being used in an integrated circuit including an ESD protection device between power supply voltages.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

Consistent with embodiments of the present invention, there are provided novel ESD protection circuits, which overcome the problems associated with conventional ESD protection circuits, for use in high-frequency ICs, e.g., ICs operable at 2 GHz or above.

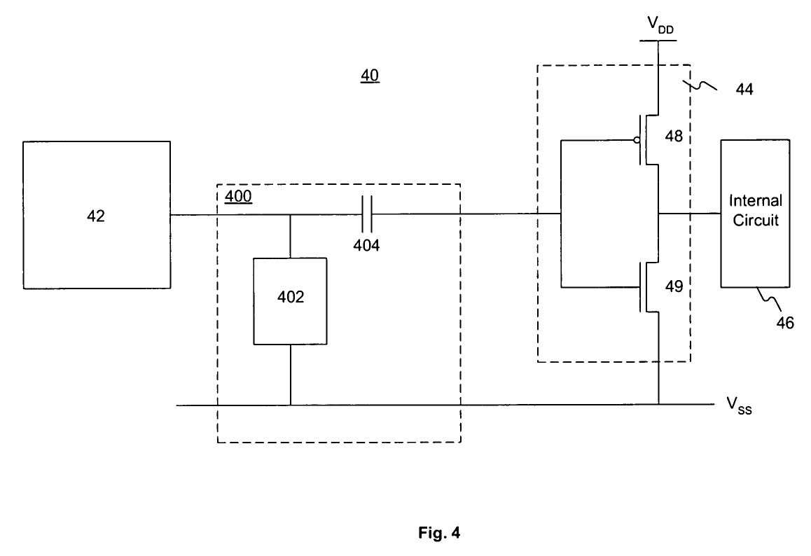

FIG. 4 shows an ESD protection circuit 400 consistent with a first embodiment of the present invention used in a high-frequency IC 40 to provide ESD protection for IC 40. IC 40 includes a contact pad or bonding pad 42, a driver circuit 44, and an internal circuit 46. An ESD event such as an HBM ESD or an MM ESD may occur on contact pad 42. Driver circuit 44 is coupled to a positive power supply voltage V_{DD} and a negative power supply voltage or ground V_{SS} and includes a PMOS transistor 48 and an NMOS transistor 49. Each of PMOS transistor 48 and NMOS transistor 49 includes a source, a drain, and a gate. The source of PMOS transistor 48 is coupled to V_{DD}. The source of NMOS transistor 49 is coupled to V_{SS}. Both the drains of PMOS transistor 48 and NMOS transistor 49 are coupled to internal circuit 46.

ESD protection circuit 400 is coupled between contact pad 42 and driver circuit 44 to protect driver circuit 44 and internal circuit 46 against an ESD on contact pad 42. Consistent with the first embodiment of the present invention, ESD protection circuit 400 includes an ESD protection device 402 and a capacitor 404. ESD protection device 402 is coupled between contact pad 42 and V_{SS} and may comprise a conventional ESD protection device, such as an SCR or a grounded-gate MOS transistor, etc. An SCR and a grounded-gate MOS transistor are well known to one skilled in the art and are not described herein. ESD protection device 402 is turned on to discharge the ESD on contact pad 42 when a voltage across ESD protection device 402 exceeds a triggering voltage thereof. Capacitor 404 is coupled between contact pad 42 and driver circuit 44, and may comprise any suitable capacitor, such as a metal-insulator-metal (MIM) capacitor.

Because IC 40 is a high-frequency circuit, signals are normally at high frequencies. In one aspect, capacitor 404 has an impedance that is substantially smaller than an equivalent impedance of driver circuit 44 for normal operating signals of IC 40 such that capacitor 404 is virtually transparent to the normal operating signals. In contrast, an ESD voltage on contact pad 42 generally only contains low frequency components and an impedance of capacitor 404 at the frequency components of the ESD voltage is much higher. Thus, capacitor 404 divides the ESD voltage so that only a small portion of the ESD voltage reaches the gates of PMOS transistor 48 and NMOS transistor 49, thereby effectively protecting driver circuit 44 against the ESD on contact pad 42.

Therefore, when an ESD occurs on contact pad 42, ESD protection circuit 400 consistent with the first embodiment of the present invention provides efficient ESD protection. When normal operating signals are passed onto driver circuit 44, capacitor 404 is virtually transparent to these signals and problems of decreased power gain and increased circuit noise are avoided.

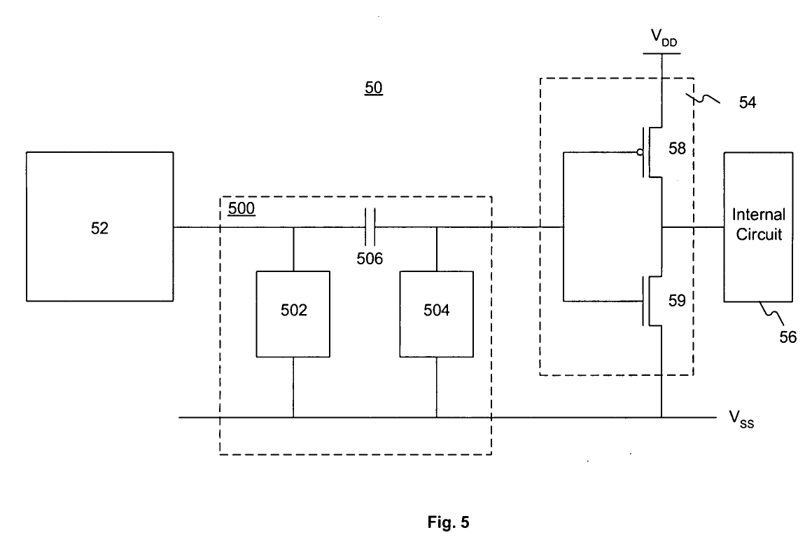

Consistent with a second embodiment of the present invention, there is provided a multi-stage ESD protection circuit suitable for protecting a high-frequency IC. FIG. 5 shows an ESD protection circuit 500 consistent with the second embodiment of the present invention used in a high-frequency IC 50 to provide ESD protection for IC 50.

IC 50 includes a contact pad 52, a driver circuit 54, and an internal circuit 56. An ESD event such as an HBM ESD or an MM ESD may occur on contact pad 52. Driver circuit 54 is coupled between a positive power supply voltage V_{DD} and a negative power supply voltage or ground V_{SS} and includes a PMOS transistor 58 and an NMOS transistor 59. Each of PMOS transistor 58 and NMOS transistor 59 includes a source, a drain, and a gate. The source of PMOS transistor 58 is coupled to V_{DD}. The source of NMOS transistor 59 is coupled to V_{SS}. Both the drains of PMOS transistor 58 and NMOS transistor 59 are coupled to internal circuit 56. Internal circuit 56 is a high-frequency circuit.

ESD protection circuit 500 is coupled to contact pad 52 to protect driver circuit 54 and internal circuit 56 against an ESD on contact pad 52. Consistent with the second embodiment of the present invention, ESD protection circuit 500 includes a primary ESD protection device 502, a secondary ESD protection device 504, and a capacitor 506. Primary ESD protection device 502 is coupled between contact pad 52 and V_{SS} and may comprise a conventional ESD protection device, such as an SCR or a grounded-gate MOS transistor, etc. Secondary ESD protection device 504 is coupled between the gates of PMOS transistor 58 and NMOS transistor 59 and V_{SS} and may comprise a diode or a grounded-gate MOS transistor, etc. As shown in FIG. 5, capacitor 506 is coupled between devices 502 and 504. Primary ESD protection device 502 may comprise a conventional ESD protection device, such as an SCR or a grounded-gate MOS transistor, etc. Secondary ESD protection device 504 may comprise a diode or a grounded-gate MOS transistor. Capacitor 506 is coupled between contact pad 52 and driver circuit 54, and may comprise any suitable capacitor.

Primary ESD protection device 502 is turned on to discharge the ESD on contact pad 52 when a voltage across ESD protection device 502 exceeds a triggering voltage thereof. Because IC 50 is a high-frequency circuit, signals are normally at high frequencies. In one aspect, for normal operating signals of IC 50, capacitor 506 has an impedance that is substantially smaller than an equivalent impedance of a combination of driver circuit 54 and secondary ESD protection device 504, such that capacitor 506 is virtually transparent to the normal operating signals. However, an ESD voltage on contact pad 52 generally contains only low frequency components and an impedance of capacitor 506 at the frequency components of the ESD voltage is much higher. Therefore, capacitor 506 divides the ESD voltage so that only a portion of the ESD voltage reaches secondary ESD protection device 504 and the gates of PMOS transistor 58 and NMOS transistor 59. Secondary ESD protection device 504 is designed such that the portion of the ESD voltage reaching the gates of PMOS transistor 58 and NMOS transistor 59, if still high enough to damage driver circuit 54, is discharged through secondary ESD protection device 504.

As discussed above, an ESD protection circuit consistent with the second embodiment of the present invention provides multiple stages of ESD protections without increasing circuit noise or decreasing power gain.

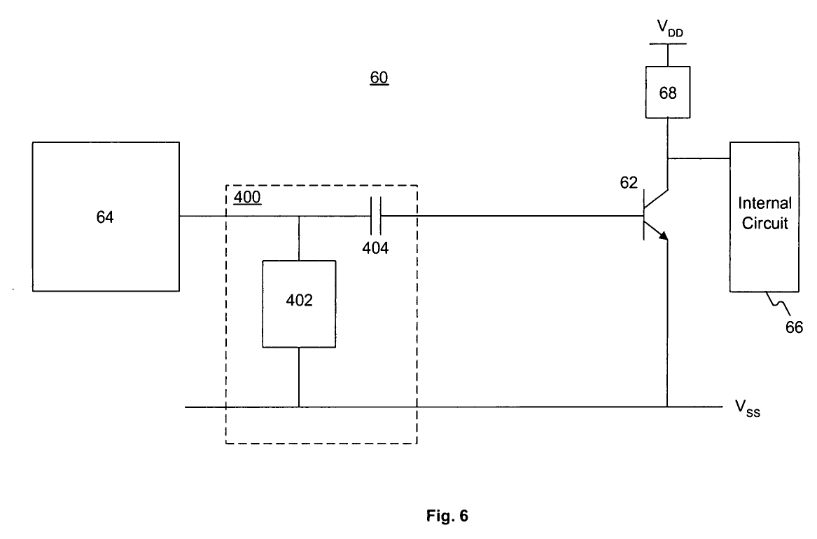

In the above discussions, it was assumed that a driver circuit comprises a CMOS device. It is to be understood that a driver circuit may comprise any conventional driver circuit. For an example, instead of a CMOS device, a bipolar junction transistor (BJT) may be used as a driver in ICs. FIG. 6 shows ESD protection circuit 400 consistent with the first embodiment of the present invention being used to provide ESD protection in a high-frequency IC 60 using a BJT 62 as a driver.

As shown in FIG. 6, IC 60 includes a contact pad 64 coupled to ESD protection circuit 400, which is further coupled to an internal circuit 66 through BJT 62. An ESD event such as an HBM ESD or an MM ESD may occur on contact pad 64, and ESD protection circuit 400 protects BJT 62 and internal circuit 66 against the ESD. BJT 62 includes a base, an emitter, and a collector. The base of BJT 62 is coupled to ESD protection circuit 400. The emitter of BJT 62 is coupled to a negative power supply voltage or ground V_{SS}. The collector of BJT 62 is connected to a load 68, which is further coupled to a positive power supply voltage V_{DD}. The collector of BJT 62 is also coupled to internal circuit 66 to provide signals.

The operations of ESD protection circuit 400 are the same as discussed above and are not repeated herein.

Alternatively, an ESD protection circuit consistent with the second embodiment of the present invention may also be used to provide ESD protection in a high-frequency IC using a BJT as a driver circuit. Such modification should now be apparent to one skilled in the art and is not described in detail herein.

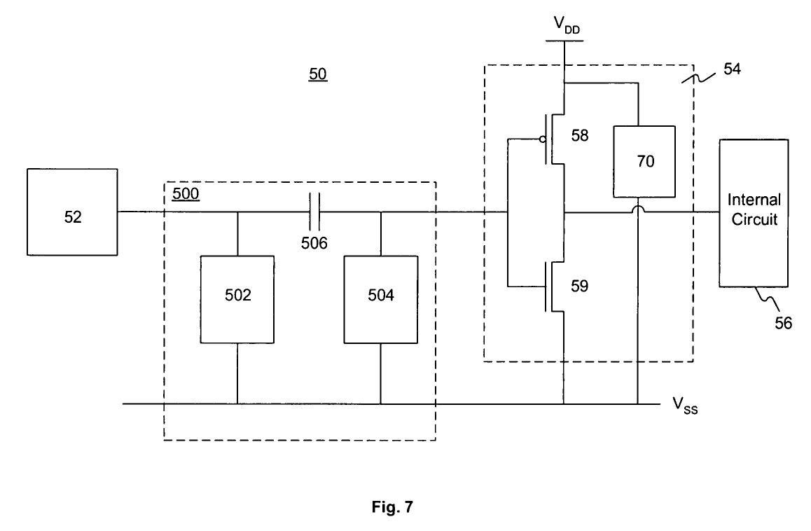

For another example, a driver circuit may include, in addition to a CMOS device, an ESD protection device between V_{DD} and V_{SS} to provide protection against an ESD occurring on V_{DD}. FIG. 7 shows IC 50 of FIG. 5 being modified such that driver circuit 54 further includes an ESD protection device 70 between V_{DD} and V_{SS}. ESD protection device 70 may comprise any suitable ESD protection device such as an SCR or a grounded-gate MOS transistor, etc., and provides ESD protection against an ESD occurring on V_{DD}.

Alternatively, driver circuit 44 in FIG. 4 may also include an ESD protection device between V_{DD} and V_{SS} to provide protection against an ESD occurring on V_{DD}. Such variation should now be apparent to one skilled in the art and is not illustrated in the drawings.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An electrostatic discharge (ESD) protection circuit for use in an integrated circuit (IC) to provide protection against an ESD on a contact pad of the IC, the IC comprising a driver circuit, the ESD protection circuit being connectable to a first power supply voltage and comprising:
an ESD protection device connectable between the contact pad and the first power supply voltage; and
a capacitor connectable between the contact pad and the driver circuit,
wherein an impedance of the capacitor is substantially smaller than an equivalent impedance of the driver circuit for normal operating signals of the IC.

2. The circuit of claim 1, wherein the ESD protection device comprises a silicon controlled rectifier or a grounded-gate MOS transistor.

3. The circuit of claim 1, wherein the capacitor comprises a metal-insulator-metal capacitor.

4. (canceled)

5. The circuit of claim 1, wherein the driver circuit comprises a PMOS transistor and an NMOS transistor each having a gate, and the capacitor is connectable to both the gate of the PMOS transistor and the gate of the NMOS transistor.

6. The circuit of claim 1, wherein the driver circuit comprises a bipolar junction transistor (BJT) having a base, and the capacitor is connectable to the base of the BJT.

7. The circuit of claim 1, wherein the driver circuit comprises a protection circuit coupled between the first power supply voltage and a second power supply voltage for providing protection against an ESD occurring on the second power supply voltage, and wherein the first power supply voltage is a ground or a negative power supply voltage and the second power supply voltage is a positive power supply voltage.

8. An electrostatic discharge (ESD) protection circuit for use in a high-frequency integrated circuit (IC) to provide protection against an ESD on a bonding pad of the IC, the IC comprising a driver circuit, the ESD protection circuit being connectable to a first power supply voltage and comprising:
a primary ESD protection device connectable between the bonding pad and the first power supply voltage for providing a primary ESD protection;
a secondary ESD protection device connectable to the first power supply voltage and the driver circuit for providing a secondary ESD protection; and
a capacitor connectable between the bonding pad and the driver circuit and also coupled between the primary ESD protection device and the secondary ESD protection device,
wherein an impedance of the capacitor is substantially smaller than an equivalent impedance of the driver circuit for normal operating signals of the IC.

9. The circuit of claim 8, wherein the primary ESD protection device comprises a silicon controlled rectifier or a grounded-gate MOS transistor.

10. The circuit of claim 8, wherein the secondary ESD protection device comprises a diode or a grounded-gate MOS transistor.

11. The circuit of claim 8, wherein the capacitor comprises a metal-insulator-metal capacitor.

12. (canceled)

13. The circuit of claim 8, wherein the driver circuit comprises a PMOS transistor and an NMOS transistor each having a gate, and the capacitor and the secondary ESD protection device are connectable to both the gate of the PMOS transistor and the gate of the NMOS transistor.

14. The circuit of claim 8, wherein the driver circuit comprises a bipolar junction transistor (BJT) having a base, and the capacitor and the secondary ESD protection device are connectable to the base of the BJT.

15. The circuit of claim 9, wherein the driver circuit comprises a protection circuit coupled between the first power supply voltage and a second power supply voltage for providing protection against an ESD occurring on the second power supply voltage, and wherein the first power supply voltage is a ground or a negative power supply voltage and the second power supply voltage is a positive power supply voltage.

16. A high-frequency integrated circuit (IC), comprising:
a bonding pad;
a driver circuit; and
an ESD protection circuit to protect the IC against an ESD on the bonding pad, comprising
a primary ESD protection device coupled to the bonding pad and connectable to a first power supply voltage for providing a primary ESD protection, and
a capacitor coupled between the bonding pad and the driver circuit,
wherein an impedance of the capacitor is substantially smaller than an equivalent impedance of the driver circuit for normal operating signals of the IC.

17. The IC of claim 16, wherein the primary ESD protection device comprises a silicon controlled rectifier or a grounded-gate MOS transistor.

18. The IC of claim 16, wherein the capacitor comprises a metal-insulator-metal capacitor.

19. (canceled)

20. The IC of claim 16, wherein the driver circuit includes a PMOS transistor and an NMOS transistor each having a gate, and the capacitor is coupled to both the gate of the PMOS transistor and the gate of the NMOS transistor.

21. The IC of claim 16, wherein the driver circuit includes a bipolar junction transistor (BJT) having a base, and the capacitor is coupled to the base of the BJT.

22. The IC of claim 16, further comprising a protection circuit connectable between the first power supply voltage and a second power supply voltage for providing protection against an ESD occurring on the second power supply voltage, wherein the first power supply voltage is a ground or a negative power supply voltage and the second power supply voltage is a positive power supply voltage.

23. The IC of claim 16, further comprising a secondary ESD protection device connectable to the first power supply voltage and coupled between the capacitor and the driver circuit for providing a secondary ESD protection.
